(19) United States
(12) Patent Application Publication
(10) Pub. No.: US 2009/0213204 A1
(43) Pub. Date: Aug. 27, 2009

(54) Video capture device

(75) Inventor: CHARLENE WONG, Taipei City (TW)

Correspondence Address: BACON & THOMAS, PLLC, 625 SLATERS LANE, FOURTH FLOOR, ALEXANDRIA, VA, 22314-1176, US

(73) Assignee: FIRST INTERNATIONAL COMPUTER, INC., Taipei (TW)

(21) Appl. No.: 12/149,048

(22) Filed: Apr. 25, 2008

(30) Foreign Application Priority Data
Feb. 22, 2008 (TW) 097106386

(51) Int. Cl. H04N 7/14

(52) U.S. Cl. 348/14.02; 348/E07.077

(57) ABSTRACT

A video capture device comprises an image sensor, a voice sensor, a control circuit, and a battery module all installed in a housing. The housing comprises a fixture capable of being fixed at a shoulder position of clothing. The image sensor is arranged at a proper angle to capture facial images of a user.

### BACKGROUND OF THE INVENTION

1. Field of the Invention

The present invention relates to a video capture device; more specifically, the present invention relates to a video capture device capable of being fixed on an article of clothing at a shoulder position of a user. An image sensor of the video capture device can capture a facial image of the user from the shoulder position of the user.

2. Description of the Related Art

Video capture devices are becoming more compact as the related technology improves. The recorded image and voice data can be transmitted by a wireless transmission module or stored in a memory.

The video capture device of the prior art, such as those found in a 3G mobile phone, comprises a video camera, and the recorded image data can be transmitted wirelessly to another 3G mobile phone. The current 3G mobile phone can be used as a monitor camera with various functions such as two-way communication, image recording, voice recording, and photographing. During the video communication, the video camera can be controlled by keys of the mobile phone. Some products have night view functions and infrared recording functions for capturing image in low light environments. Other products have embedded memory for directly storing captured images. The captured images can be sent to a predetermined mobile in an MMS (Multimedia Messaging Service) short message for the purpose of monitoring. This kind of monitor capture device is located in the guarding place.

Taiwan patent publication No. 584997 discloses a method and device for personal security. The personal security device comprises a mini video camera, a central processor, a recording unit, a playing unit, an antenna, a power unit, and an emergency alarm button. The personal security device also has a lanyard for portable use. A hand is needed to hold the personal security device for capturing images and to press the emergency alarm button.

U.S. Pat. No. 6,704,044 discloses another video capture device. The image sensor is installed in the front visor of a cap, and the captured image can be transmitted wirelessly to a remote station. U.S. Pat. No. 4,516,157 discloses a video capture device installed on glasses. In addition, U.S. Pat. No. 5,610,678, U.S. Pat. No. 667,771, and U.S. Pat. No. 6,806,868 disclose a video capture device capable of being clipped on a pocket of an article of clothing. The above video capture devices can only capture images in front of the user.

In addition, U.S. Pat. No. 6,943,843 discloses a video capture device comprising a magnet or double-sided tape for attaching to a frame of a monitor in order to capture images of a user in front of the monitor.

People's moods can be shown on their faces. Only a video camera can record people's facial image and transmit it. It is hard for a young child or elderly handicapped person to adjust a video camera such that it is aimed at his or her face. The above video cameras of the prior art are not able to capture facial images all the time, especially for young children or elderly handicapped people. Therefore, their friends or relatives cannot observe their faces to understand their emotional states with the above video cameras.

Therefore, the video capture devices of the prior art cannot capture facial images of the user all the time in order to send the images to the user's friends or relatives, especially in the case of a child or elderly user. In addition, handicapped people may not be able to use their hands to press the emergency alarm button to activate an emergency alarm. The above problems of the prior art need to be solved.

### SUMMARY OF THE INVENTION

It is therefore an object of the present invention to provide a video capture device capable of being fixed on an article of clothing at a shoulder position of a user to capture a facial image of the user for face observation.

It is another object of the present invention to provide a video capture device capable of being fixed on an article of clothing at a shoulder position of a child or an elderly person for observing the status of the child or elder.

It is another object of the present invention to provide an emergency alarm system for wirelessly transmitting video and voice data of the user that is activated by depressing an emergency alarm button with the chin.

To achieve the objects mentioned above, the video capture device of the present invention comprises an image sensor, a voice sensor, a control circuit, and a battery module all installed in a housing, and the video capture device is characterized by the housing comprising:

a fixture capable of being fixed on an article of clothing at a shoulder position of a user; and

an image fixing base for accommodating and fixing the image sensor, the image fixing base being obliquely installed on the housing to enable the image sensor to capture a facial image of the user from the shoulder position of the user.

The video capture device as mentioned above, wherein the fixture comprises at least one elastic fixing pin and one attachment base for fixing the video capture device at the shoulder position of the user's clothing.

The video capture device as mentioned above, wherein the fixture comprises at least one fixing clip, and the fixing clip consists of a clip body and a pressing part; the fixing clip has elasticity to maintain the pressure to keep the video capture device at the shoulder position of the clothing.

The video capture device as mentioned above, wherein the image fixing base comprises a ball hinge, which consists of a ball head and a corresponding circular bracket, for adjusting the view angle of the image sensor.

The video capture device as mentioned above further comprises at least one additional image sensor installed at a lateral side of the housing, wherein when the video capture device is fixed at the shoulder position of the clothing; the additional image sensor is capable of capturing images of the user's environment.

The video capture device as mentioned above further comprises a wireless transmission module for transmitting image data captured by the image sensor and voice data recorded by the voice sensor, and for receiving electrical signals sent from others.

The video capture device as mentioned above further comprises a storage device for storing the image data captured by the image sensor and the voice data recorded by the voice sensor.

Other objects, advantages, and novel features of the present invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 is an illustration of a video capture device of the present invention in use.

FIG. 2 is an illustration of a first embodiment of the video capture device of the present invention.

FIG. 3 is an illustration of the first embodiment of the video capture device of the present invention from another viewing angle.

FIG. 4 is an illustration of an emergency alarm button of the video capture device of the present invention when being depressed.

FIG. 5 is an exploded view of a ball hinge of a second embodiment of the present invention.

FIG. 6 is a cross-section view of the ball hinge of the second embodiment of the present invention.

FIG. 7 is another cross-section view of the ball hinge of the second embodiment of the present invention.

FIG. 8 is an illustration of a video capture device with a fixing clip of a third embodiment of the present invention.

FIG. 9A is a side view of the fixing clip of a third embodiment of the present invention.

FIG. 9B is a side view of the opened fixing clip of a third embodiment of the present invention.

FIG. 10 is an illustration of a video capture device with a second image sensor of a third embodiment of the present invention.

FIG. 11 is a functional block diagram of the video capture device of the present invention.

### DETAILED DESCRIPTION OF THE PREFERRED EMBODIMENT

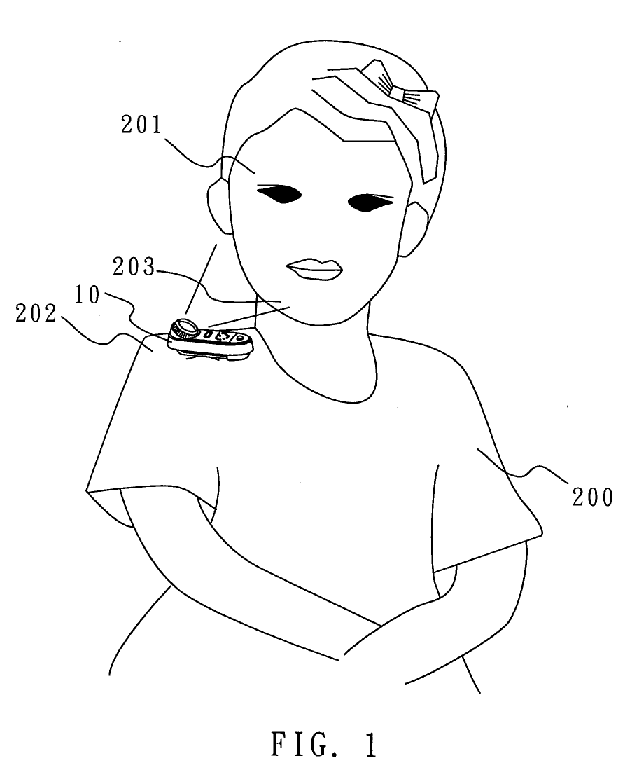

Please refer to FIG. 1 to FIG. 4, which show the first embodiment of a video capture device of the present invention. The video capture device of the present invention comprises a housing 100 accommodating electrical components inside. The housing 100 is fixed on a shoulder position 202 of an article of clothing worn on a human body 200. An image fixing base 110 and a fixture 150 are installed on the housing 100. The image fixing base 110 is obliquely installed on an upper surface of the housing 100 in order to enable the image sensor 20 to capture a face 201 image of the user from the shoulder position 202 of the user. The best oblique angle θ of the image fixing base 110 is 30° corresponding to a horizontal line. The fixture 150 is installed on a lower surface of the housing 100. The fixture 150 comprises two elastic fixing pins 151 extending from one end of the housing 100, and one attachment base 152 installed at the other end of the housing 100. The two elastic fixing pins 151 are connected together by a connecting piece 151a. The attachment base 152 has an attachment piece 152a in the middle for fastening the front ends of the two elastic fixing pins 151, and the attachment piece 152a has two attachment side pieces 152b at its two sides to prevent the front ends of the two elastic fixing pins 151 from being detached from the attachment piece 152a. The above fixture 150 can comprise one or a plurality of elastic fixing pins 151, and it is obvious that many other possible modifications and variations can be made by changing the direction and arrangement of the elastic fixing pins 151 without departing from the spirit and scope of the present invention.

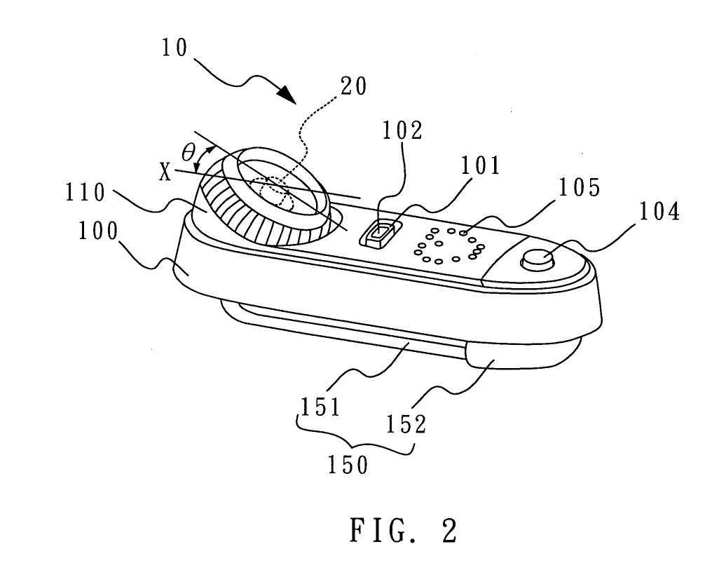

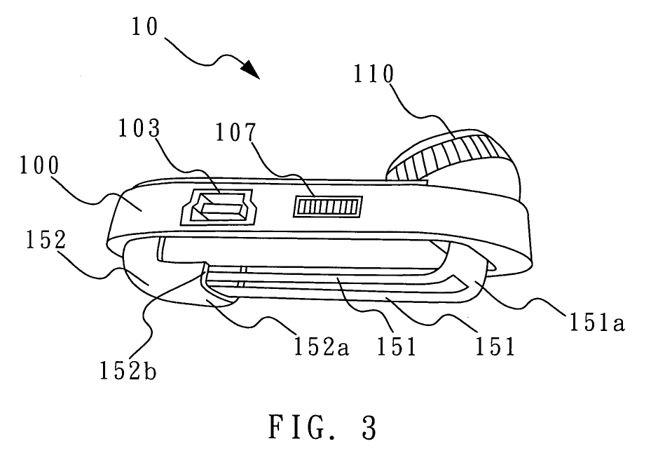

Please refer to FIG. 2 and FIG. 3. The video capture device 10 of a first embodiment of the present invention further comprises a power button 101, an indicator light 102, an input/output interface connector 103, and voice holes 105. The user can operate the video capture device 10 by the above arrangement.

In the first embodiment of the present invention, to start using the video capture device 10, the two elastic fixing pins 151 are first detached from the attachment base 152 and then re-attached to the attachment base 152 after passing through the shoulder position 202 of the clothing. The connecting piece 15 la connects the ends of the two elastic fixing pins 151 together, and the two elastic fixing pins 151 can be easily moved by pressing the connecting piece 151 a in order to attach/detach the two elastic fixing pins 151 to/from the attachment base 152. The fixture 150 can fix the video capture device 10 on the clothing at the shoulder position 202 of the human body 200. In addition, the oblique angle of the image fixing base 110 enables the image sensor to capture the face 201 image of the user.

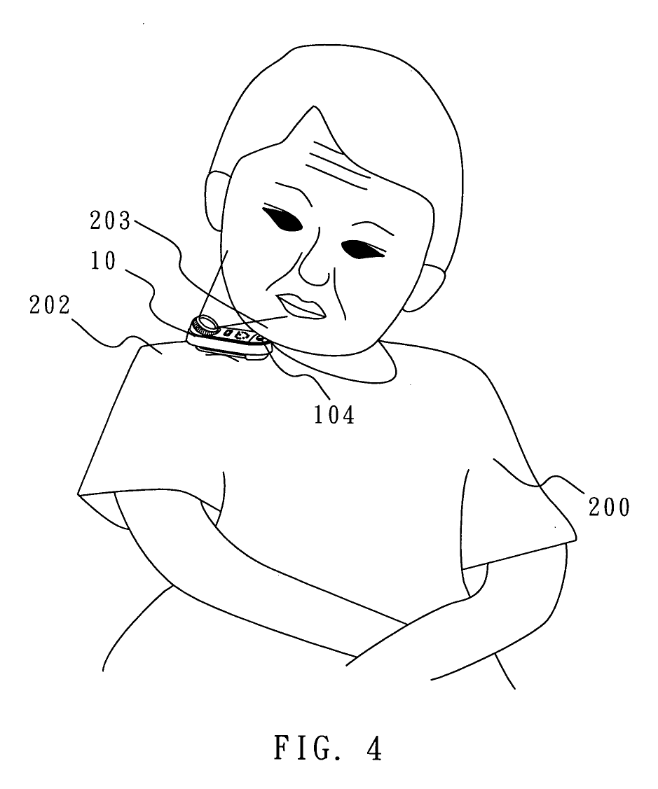

Please refer to FIG. 2 and FIG. 4, which show the operational status of the emergency alarm button 104 according to the first embodiment of the present invention. The emergency alarm button 104 is installed on the upper surface of the housing 100, and the emergency alarm button 104 is close to the neck position such that it can easily be depressed by the chin 203 of the user. Such a design is convenient for users with impaired use of their hands for purposes of activating the emergency alarm.

The image fixing base 110 of the first embodiment of the present invention is fixed and cannot be rotated. The user needs to adjust the position of the video capture device 10 in order to enable the image sensor 20 to capture the face 201 image of the user.

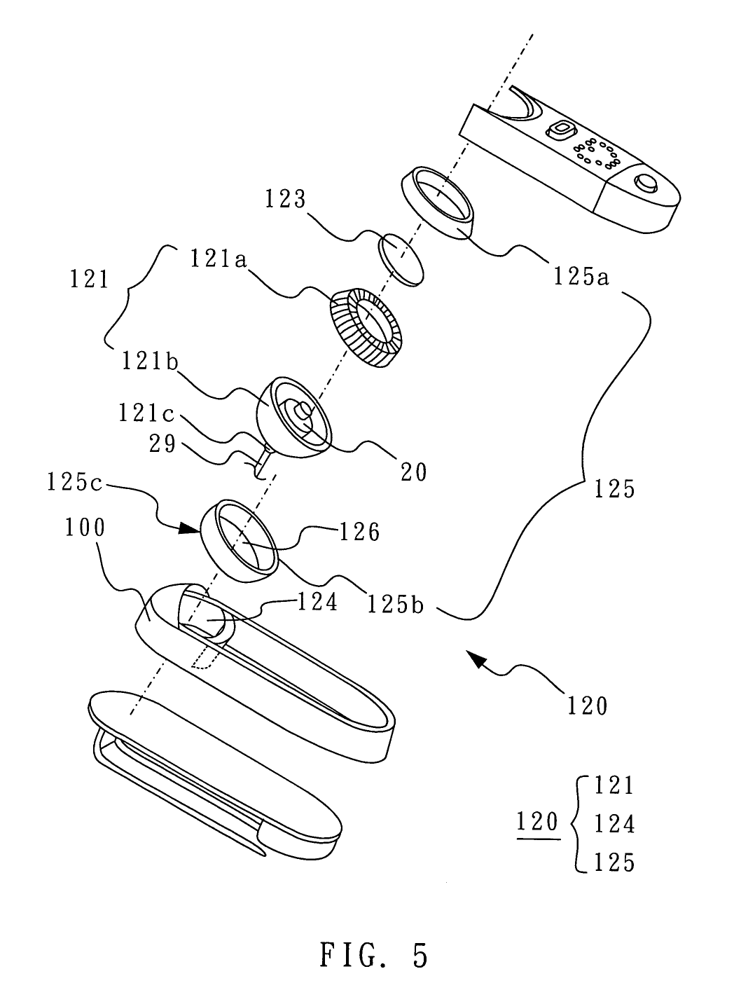

Please refer to FIG. 5 to FIG. 7 showing a video capture device according to a second embodiment of the present invention. The image fixing base 110 of the second embodiment of the present invention comprises a ball hinge 120. The ball hinge 120 consists of a ball head 121, a circular bracket 125, and a socket 124. The socket 124 is installed at one end of the housing 100 in order to accommodate the ball head 121 and the circular bracket 125. The inner surface of the circular bracket 125 corresponds to the outer surface of the ball head 121, where the inside diameter of the circular bracket 125 is substantially equal to the outside diameter of the ball head 121, in order to make the ball head 121 perfectly fit into the circular bracket 125. The ball head 121 is affixed to the circular bracket 125 in a rotatable manner to allow adjustment of the view angle of the image sensor 20.

In order to assemble the image sensor 20 into the ball head 121 easily, the ball head 121 is made of different separable parts. For example, as shown in FIG. 5, the ball head 121 consists of an upper ball body 121 a, a lower ball body 121b, and a glass 123. The glass 123 is installed on the upper ball body 121a to protect the image sensor 20. In the assembly process, the image sensor 20 is first assembled in the lower ball body 12 lb, and then the upper ball body 121a is combined with the lower ball body 121b to form the ball head 121. The ball head 121 has a bulge 121c at its rear end. There is a through hole in the middle of the bulge 121c to allow a conductive wire 29 of the image sensor 20 to pass through and electrically connect to an electrical circuit of the video capture device 10.

In order to fit the ball head 121 into the circular bracket 125 easily, the circular bracket 125 is made of different separable parts. For example, as shown in FIG. 5, the circular bracket 125 consists of an upper bracket body 125a and a lower bracket body 125b dividing the circular bracket 125 at a position with the largest diameter. Therefore, the upper bracket body 125a and the lower bracket body 125b can be combined together from above and below the ball head 121, respectively.

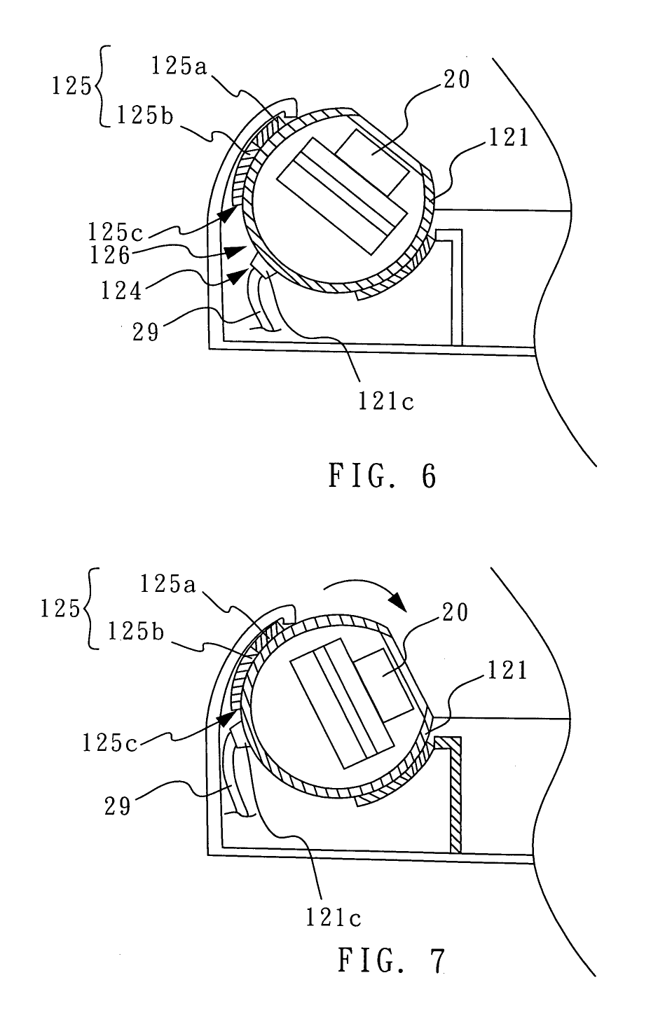

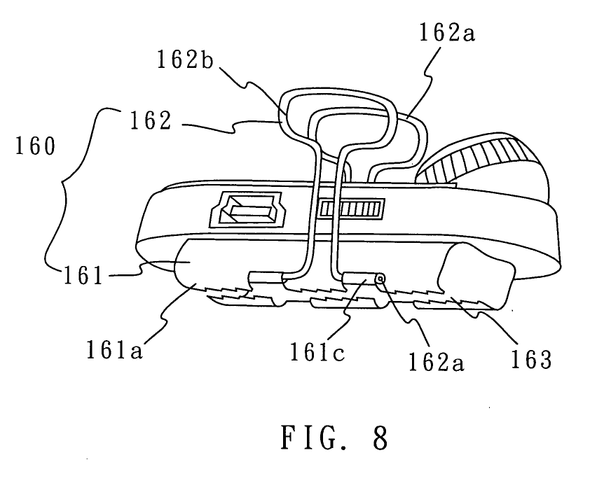

The lower bracket body 125b has a lower circular opening 126, and the surrounding of the lower circular opening 126 comprises a lower edge 125c. The distance from the top of the bulge 121c to the center of the ball head 121 is longer than the distance from the inner surface of the circular bracket 125 to the center of the ball head 121; therefore, the bulge 121c of the ball head 121 bulges out of the lower circular opening 126 after assembly. In addition, when the ball head 121 is rotated, the bulge 121c of the ball head 121 will make contact with the lower edge 125c of the circular bracket 125; the rotation range of the ball head 121 is thus restrained inside the lower circular opening 126. As shown in FIG. 6 and FIG. 7, the ball head 121 is capable of being rotated to different positions in order to adjust the image sensor 20 so that it is aimed at the face 201 of the user.

The above ball hinge 120 enables angle adjustment of the image sensor 20, and of course the ball hinge 120 can be replaced by other angle adjustment devices of the prior art.

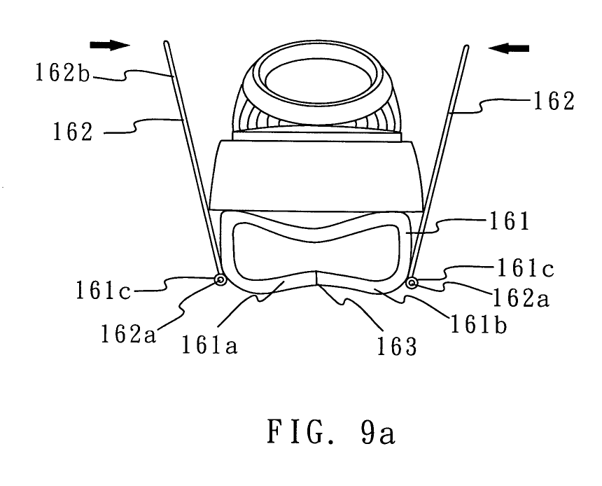

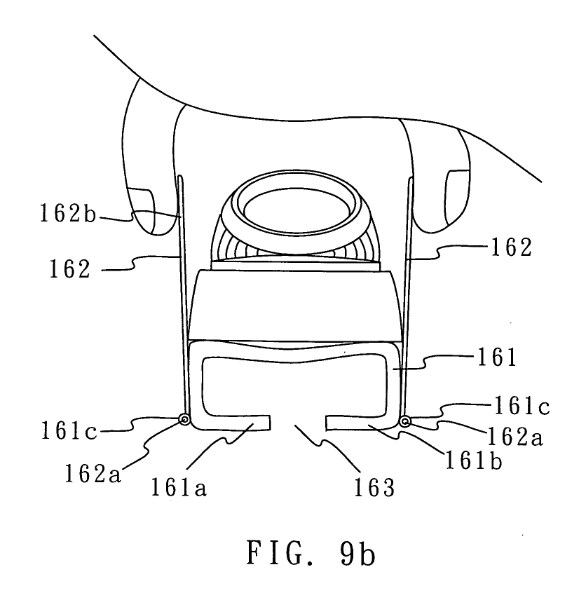

Please refer to FIG. 8, FIG. 9A, and FIG. 9B showing a video capture device according to the third embodiment of the present invention. The fixture 150 of the video capture device 10 can comprise a fixing clip 160 for clipping the video capture device 10 at the shoulder position 202 of an article of clothing. The fixing clip 160 consists of a clip body 161 and two pressing parts 162. The clip body 161 is an elastic piece with its two sides bent downward, and some parts of the two sides are further bent inward to form a left elastic piece 161a and a right elastic piece 161b. The clip body 161 is made of elastic material, and the left elastic piece 161a and the right elastic piece 161b are pressed toward each other. The contact area of the left elastic piece 161a and the right elastic piece 161b is an indented clip mouth 163. Another part of the clip body 161 is bent outward to form a pivot hole 161c at the corner. The two pressing parts 162 are connected to the two sides of the clip body 161 respectively. The pressing part 162 is made of slender rigid material. The two ends of the pressing part 162 are first bent downward to form a pressing head 162b and then bent outward about 90° to form a pivot axis 162a. The pivot axis 162a can be fitted into the pivot hole 161c for pivoting the pressing part 162 with the clip body 161.

When the fixing clip 160 is used, two fingers are needed to press the two pressing heads 162b inward (as indicated by the arrows in FIG. 9A) in order to separate the left elastic piece 161a and the right elastic piece 161b, as shown in FIG. 9B. Then the fixing clip 160 is moved to the shoulder position of the clothing so that a portion of the cloth of the clothing can be inserted into the indented clip mouth 163. The fixing clip 160 will be clipped on the cloth after being released by the fingers, such that the image sensor 20 can capture the face 201 image of the user.

The above fixing clip 160 enables the video capture device 10 to be fixed on the cloth, and of course the fixing clip 160 can be replaced by other fixing devices of the prior art without departing from the spirit and scope of the present invention.

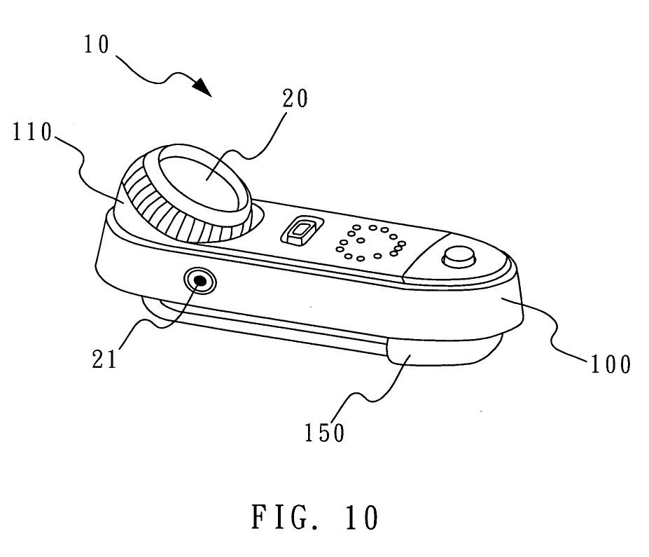

Please refer to FIG. 10, which shows a video capture device according to the fourth embodiment of the present invention. A second image sensor 21 is installed at a lateral side of the housing 100. When the video capture device 10 is fixed at the shoulder position 202 of the cloth, the second image sensor 21 is capable of capturing images in front of the user. The second image sensor 21 can be installed in other places to capture different images; for example, the second image sensor 21 can be installed to capture images to the rear or to one side of the user. The video capture device 10 of the present invention also can comprise additional a plurality of image sensors. For example, three image sensors are installed in the front, the side, and the rear of the housing 100 to capture different image of the user's environment at the same time.

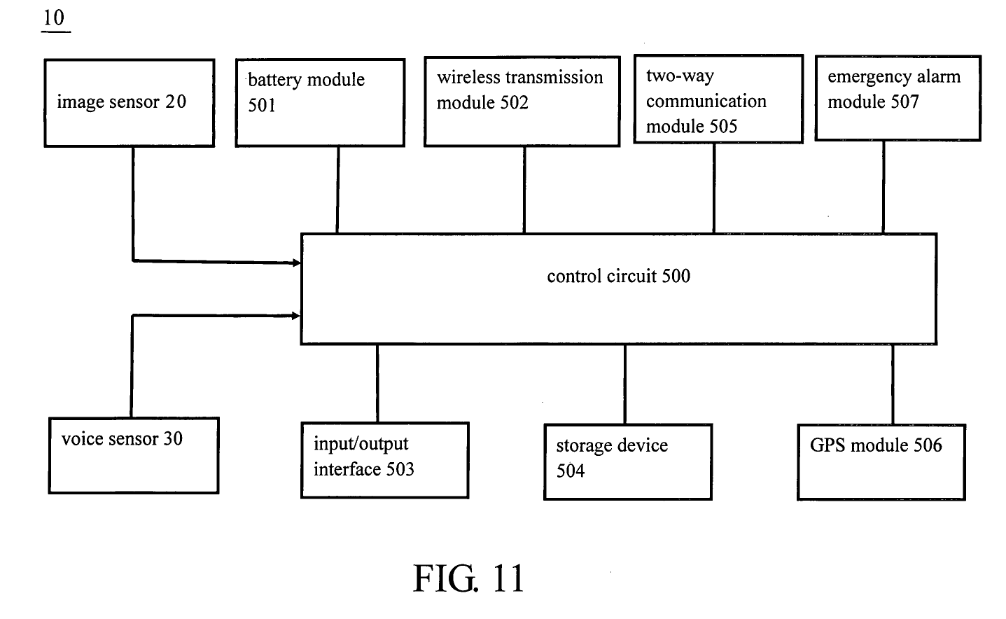

Please refer to FIG. 11 showing a block diagram of the electrical components of the video capture device according to the present invention. The video capture device 10 comprises an image sensor 20, a voice sensor 30, a battery module 501, and a control circuit 500. The image sensor 20 can capture images. The voice sensor 30 can record sound. The control circuit 500 can convert the image data and voice data into electrical signals. The battery module 501 can provide power to the video capture device 10 for recording the image data and voice data and then converting them into electrical signals.

In addition, the image sensor 20 of the present invention can be a CCD (Charge Coupled Device) sensor or a CMOS (Complementary Metal Oxide Semiconductor) sensor. The battery module 501 can comprise a recharging unit for recharging the rechargeable battery. In order to compress data for storage, the control circuit 500 can comprise a DSP (Digital Signal Processor) for converting the data into digital formats such as MP4, 3PG, WMA, etc.

The video capture device 10 of the present invention further comprises a storage device 504 for storing the electrical signals converted from the image data and voice data. The storage device 504 would best be a compact flash memory.

The video capture device 10 of the present invention further comprises a wireless transmission module 502 for transmitting the electrical signals converted from the image data and voice data, and receiving electrical signals sent from others. The wireless transmission module 502 can utilize wireless transmission techniques of the prior art. One technique is WWAN (Wireless Wide Area Network) such as the 2.5G, 2.75G, 30, and 3.5G wireless transmission modules. Another technique is WLAN (Wireless Local Area Network) such as the WiFi wireless transmission module. Another technique is WPAN (Wireless Personal Area Network) such as bluetooth (BT) or infrared wireless transmission modules.

The video capture device 10 of the present invention further comprises a two-way communication module 505 for providing two-way communication between the user and receiver of the video capture device 10.

The video capture device 10 of the present invention further comprises an input/output interface 503 for inputting or outputting the image data, voice data, and operation controlling software via the input/output interface 503.

The video capture device 10 of the present invention further comprises an emergency alarm module 507. The emergency alarm module 507 can activate an emergency alarm and transmit image data and voice data to a predetermined receiver.

The video capture device 10 of the present invention further comprises a GPS (Global Positioning System) module 506 for sensing the position of the user and transmitting the position data via the wireless transmission module 502.

The video capture device 10 of the present invention can be put at the shoulder position of the clothing to enable the image sensor 20 to capture face 201 image of the user without manual adjustment or operation. The facial image will be transmitted by the wireless transmission module 502 or recorded by the storage device 504. Besides capturing facial images, the video capture device 10 is especially suitable for children and the elderly. The video capture device 10 can further comprise an emergency alarm module 507. The emergency alarm can be activated by depressing the emergency alarm button 104 of the emergency alarm module 507 with the chin 203, which is convenient for a handicapped person. The video capture device 10 can further comprise a plurality of image sensors 20 to capture images around the user. In addition, the video capture device 10 of the present invention can have a two-way communication function or a satellite positioning function. Therefore, the video capture device 10 of the present invention is more convenient than other kinds of video capture device in the prior art and solves the problem of capturing face 201 images all the time.

Although the present invention has been explained in relation to its preferred embodiments, it is to be understood that many other possible modifications and variations can be made without departing from the spirit and scope of the invention as hereinafter claimed.

What is claimed is:

1. A video capture device comprising an image sensor, a voice sensor, a control circuit, a memory, and a battery module all installed in a housing, the video capture device characterized by the housing comprising:
a fixture capable of being fixed at a shoulder position of clothing; and
an image fixing base for accommodating and fixing the image sensor, the image fixing base being obliquely installed on the housing for enabling the image sensor to capture a facial image of a user.

2. The video capture device as claimed in claim 1, wherein the fixture comprises at least one elastic fixing pin and one attachment base for fixing the video capture device at the shoulder position of the clothing.

3. The video capture device as claimed in claim 1, wherein the fixture comprises at least one fixing clip, and the fixing clip consists of a clip body and a pressing part; the fixing clip has elasticity to maintain pressure for clipping at the shoulder position of the clothing.

4. The video capture device as claimed in claim 1, wherein the image fixing base comprises a ball hinge, which consists of a ball head and a corresponding circular bracket, for adjusting the view angle of the image sensor.

5. The video capture device as claimed in claim 4, wherein the ball head has a bulge at its rear end; the distance from a top of the bulge to a center of the ball head is longer than the distance from the inner surface of the circular bracket to the center of the ball head, such that the circular bracket restrains the bulge to only move inside a lower opening of the circular bracket.

6. The video capture device as claimed in claim 1, further comprising at least one additional image sensor installed at a lateral side of the housing, such that when the video capture device is fixed at the shoulder position of the clothing, the at least one additional image sensor is capable of capturing images of the user's environment.

7. The video capture device as claimed in claim 1 or 6 further comprising a wireless transmission module for transmitting image data captured by the image sensor and voice data recorded by the voice sensor, and for receiving electrical signals sent from others.

8. The video capture device as claimed in claim 7, wherein the wireless transmission module can be a wireless transmission module for Wireless Wide Area Network (WWAN), Wireless Local Area Network (WLAN), or Wireless Personal Area Network (WPAN).

9. The video capture device as claimed in claim 8, wherein the wireless transmission module can be a 3G wireless transmission module, a 3.5G wireless transmission module, a 2.4G wireless transmission module, a bluetooth wireless transmission module, or an infrared wireless transmission module.

10. The video capture device as claimed in claim 1 or 6, further comprising a storage device for storing the image data captured by the image sensor and the voice data recorded by the voice sensor.

11. The video capture device as claimed in claim 1 or 6, further comprising an input/output interface for inputting or outputting image data, voice data, and operation controlling software via a connector of the input/output interface.

12. The video capture device as claimed in claim 7, further comprising a two-way communication module for providing two-way communication between the user and receiver of the video capture device.

13. The video capture device as claimed in claim 1 or 6, further comprising an operation unit, the operation unit comprising a power switch, a volume adjustment key, and a status indicator light.

14. The video capture device as claimed in claim 7, further comprising an emergency alarm module with an emergency alarm button; the emergency alarm module can activate an emergency alarm and transmit image data and voice data to a predetermined receiver.

15. The video capture device as claimed in claim 14, wherein the emergency alarm button is installed on an upper surface of the housing; the emergency alarm button and the image fixing base are located at different ends.

16. The video capture device as claimed in claim 1 or 6, wherein the image sensor is a CCD (Charge Coupled Device) sensor or a CMOS (Complementary Metal Oxide Semiconductor) sensor.

17. The video capture device as claimed in claim 1 or 6, wherein the battery module comprises a recharging unit for recharging the battery.

18. The video capture device as claimed in claim 14, further comprising a GPS (Global Positioning System) module for sensing and transmitting the position of the user.

19. The video capture device as claimed in claim 1, further comprising a second image sensor installed at a lateral side of the housing, wherein when the video capture device is fixed at the shoulder position of the clothing, the second image sensor is capable of capturing images in front of the user.
